(19) United States
(12) Patent Application Publication
(10) Pub. No.: US 2013/0240417 A1
(43) Pub. Date: Sep. 19, 2013

(54) MECHANICAL PLANT HARVESTING DEVICES

(71) Applicant: Josh Kelly, Oregon City, OR (US)

(72) Inventor: Josh Kelly, Oregon City, OR (US)

(21) Appl. No.: 13/665,686

(22) Filed: Oct. 31, 2012

(51) Int. Cl. B07B 1/22

(52) U.S. Cl. 209/288

(57) ABSTRACT

Mechanical plant harvesting devices for harvesting crops from plant material including saddles, harvesting containers, and mechanical actuators. In some examples, the saddles define harvesting container-proximate regions over portions of the surface areas and saddle openings positioned within the harvesting container-proximate regions. In some examples, the harvesting containers define exterior surfaces proximate the saddles over at least a portion of the harvesting container-proximate regions of the saddles and harvesting container openings in the exterior surfaces. In some examples, the rotary actuators are mechanically connected to the harvesting containers and are configured to rotationally drive the harvesting containers through ranges of rotation. In some examples, portions of the harvesting container openings and portions of the saddle openings overlap at one or more harvesting positions in the mechanical actuators' ranges of rotation. Some examples may additionally or alternatively include fine meshes and/or harvesting containers interchangeably connected to mechanical actuators.

### BACKGROUND

The present disclosure relates generally to mechanical plant harvesting devices. In particular, mechanical plant harvesting devices that may include continuous, cyclical modes of operation that do not require removal and reinsertion of plant material, interchangeable features, and/or additional or alternative features adapted to increase efficacy in trimming dry plant material are described.

Known mechanical plant harvesting devices are not entirely satisfactory for the range of applications in which they are employed. For example, many existing devices do not include automatic mechanical features, such as electrically powered motors, which may allow plants to be harvested using repetitive mechanical processes with minimal human labor. Further, some conventional plant harvesting devices, particularly trimming devices that may provide automatic mechanical operation require plant material to be removed and reintroduced into the trimming device several times to fully harvest the crop from undesired portions of the plants. Many examples include, for example, substantially linear mechanisms that require plant material to be repeatedly sent through a trimming mechanism and output partially harvested plant material which must be reintroduced multiple times to adequately harvest the crop from the undesired portions of the plant. Such systems require a great deal of continuous human attention and labor. Thus, there exists a need for a harvesting mechanism that obviates the need for this reintroduction mechanism through a cyclical, repetitive process that does not require consistent user intervention.

Additionally or alternatively, many known mechanical plant harvesting devices are not adequately equipped to trim dry plants. Many existing devices are unable to retain plant material in a harvestable position when dry. Further, many existing devices do not have adequate mechanisms for handling stray particulate matter or fire hazards.

Additionally or alternatively, many conventional harvesting devices lack adequate detachability and interchangeability of harvesting mechanisms. As a result, many devices are unable to adapt to harvest disparate plant materials or perform disparate harvesting tasks. For example, many devices relating to harvesting plants that produce harvestable buds or flowers, such as hops, are unable to subsequently grind the resultant crop down to more fine particulate matter, as is often desired. As a result, users that require that functionality are often required to purchase a wholly separate product. Thus, to achieve desired results, many conventional systems require users to use two or more separate machines: one for each individual harvesting task. Thus, there exists a need for a device that may be adapted to each of these harvesting tasks.

Thus, there exists a need for mechanical plant harvesting devices that improve upon and advance the design of known plant harvesting devices. Examples of new and useful mechanical plant harvesting devices relevant to the needs existing in the field are discussed below.

### SUMMARY

The present disclosure is directed to mechanical plant harvesting devices for harvesting crops from plant material including saddles, harvesting containers, and rotary actuators. In some examples, the saddles define harvesting container-proximate regions over portions of the surface areas and saddle openings positioned within the harvesting container-proximate regions. In some examples, the harvesting containers define exterior surfaces proximate the saddles over at least a portion of the harvesting container-proximate regions of the saddles and harvesting container openings in the exterior surfaces. In some examples, the rotary actuators are mechanically connected to the harvesting containers and are configured to rotationally drive the harvesting containers through ranges of rotation. In some examples, portions of the harvesting container openings and portions of the saddle openings overlap at one or more harvesting positions in the mechanical actuators' ranges of rotation. Some examples may additionally or alternatively include fine meshes and/or harvesting containers interchangeably connected to mechanical actuators.

### BRIEF DESCRIPTION OF THE DRAWINGS

FIG. 1 is a front perspective view of a first example of a mechanical plant harvesting device.

FIG. 2 is a rear perspective view of the mechanical plant harvesting device shown in FIG. 1.

FIG. 3 is a side elevation cutaway view of the mechanical plant harvesting device shown in FIG. 1 illustrating a saddle, a harvesting container, and a motor.

FIG. 4 is an exploded view of the mechanical plant harvesting device shown in FIG. 1.

FIG. 5 is perspective, close-up view showing a unit of plant material with an undesired portion of the plant material partially received within a harvesting container opening a saddle opening and a crop of the plant material maintained within a harvesting space.

FIG. 6 is a perspective view of a second example of a harvesting container configured to be interchangeably connected to disclosed mechanical plant harvesting devices.

FIG. 7 illustrates a second example of a mechanical plant harvesting device.

### DETAILED DESCRIPTION

The disclosed mechanical plant harvesting devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various mechanical plant harvesting devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

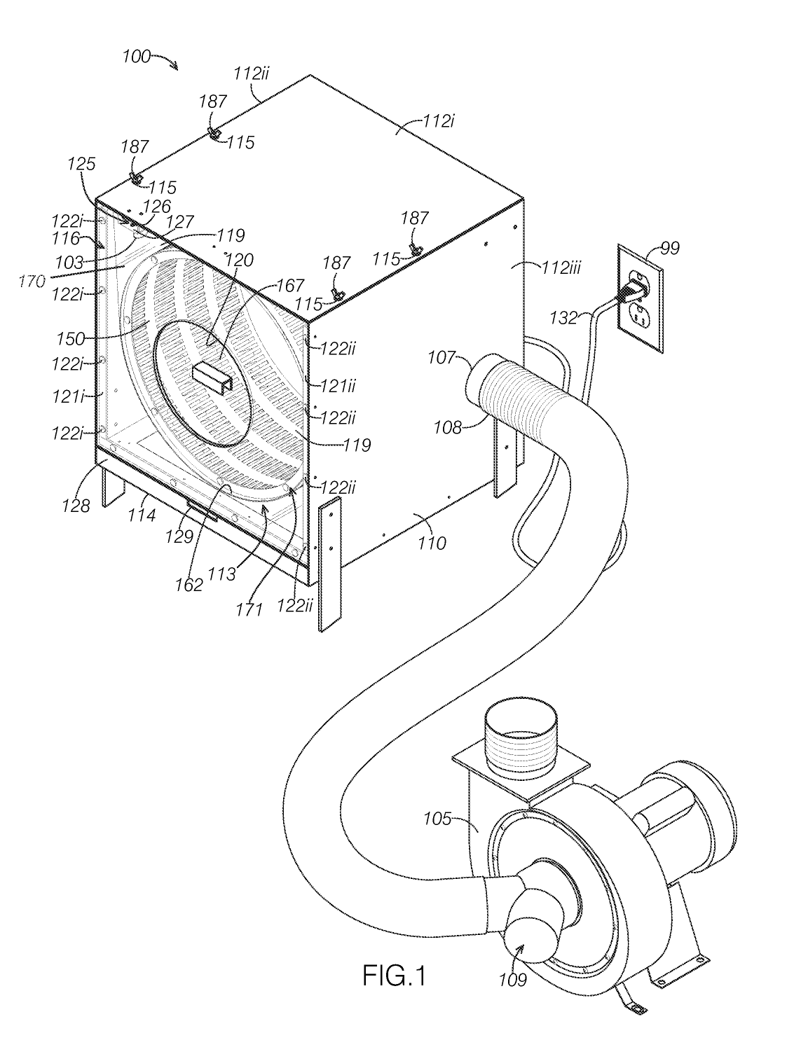

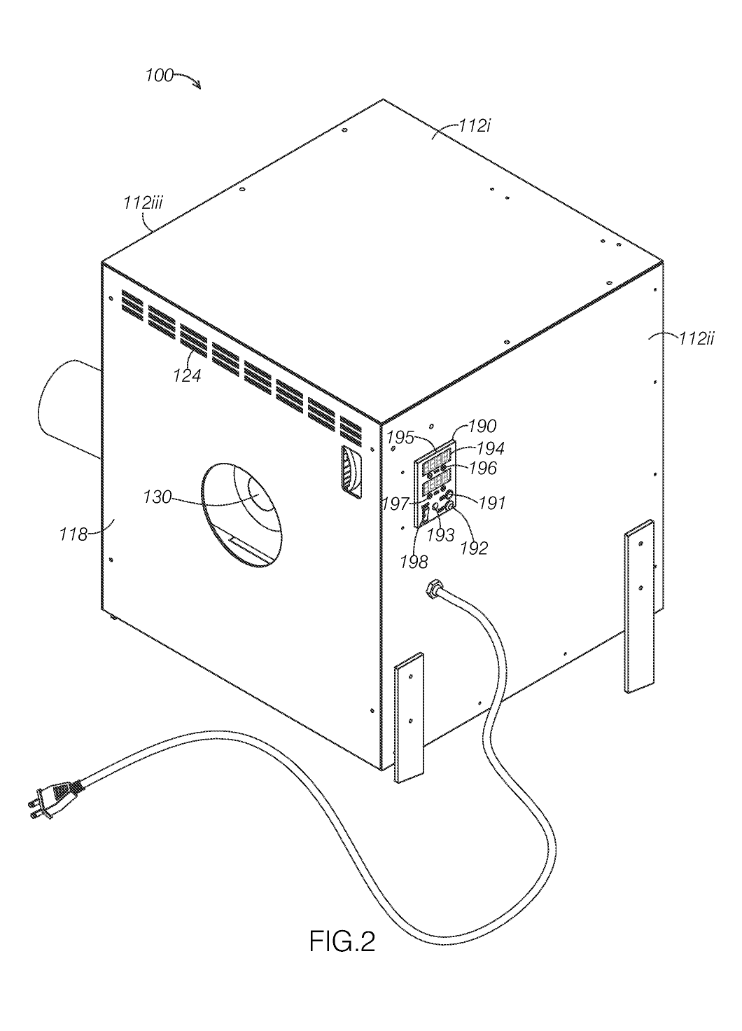

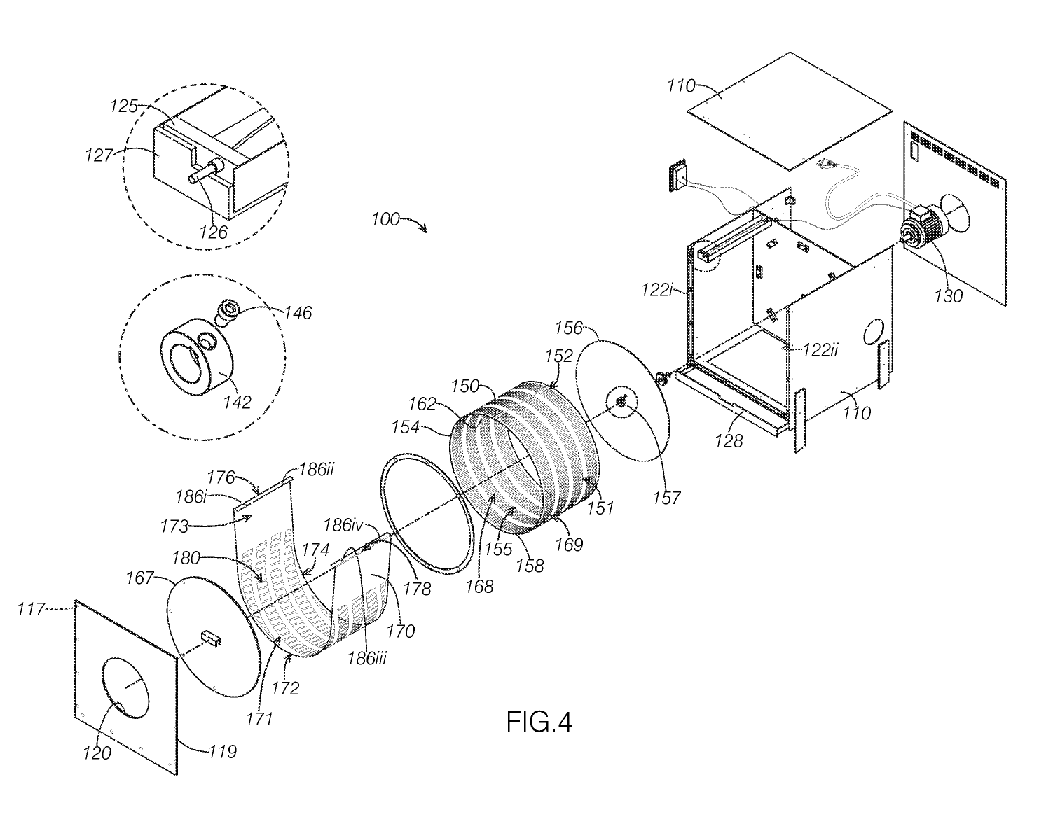

With reference to FIGS. 1-5, a first example of a mechanical plant harvesting device, device 100, for harvesting crops from plant material will now be described. As FIG. 4 illustrates, device 100 includes a case 110, a motor 130, a harvesting container 150, and a saddle 170. As FIG. 2 shows, device 100 includes a control panel 190. As FIGS. 1-5 illustrate, device 100 provides a substantially cyclical harvesting operation, which requires no unloading and/or reintroduction of the plant material to fully harvest the plant. Indeed, device 100 allows users to harvest plants without consistent intervention; rather, device 100 provides users with a one step harvesting operation. Some examples may also include interchangeable elements that may allow users to modify device 100 to adapt to particular uses. Additionally or alternatively, device 100 includes several features that may increase its effectiveness in trimming dry plant material.

As FIG. 1 shows, case 110 encloses substantially all of device 100's operable harvesting features, including harvesting container 150 and saddle 170, in a case interior space 113. As FIG. 1 shows, case 110 defines a plurality of substantially metallic panels, including a top panel 112i, a first side panel 112ii, a second side panel 112iii. As FIG. 1 illustrates, case 110 additionally defines a bottom portion 114. As FIGS. 1 and 2 show, case 110 additionally includes a plurality of legs 111 extending from bottom portion 114. As FIG. 1 shows, case 110 defines a substantially open open panel 116, through which case 110 may be accessed from case 110's exterior. As FIG. 2 illustrates, case 110 defines a rear panel 118 opposite open panel 116. As FIG. 1 shows, case 110 includes a case access cover 119. As FIGS. 1 and 2 collectively show, each of case 110's panels are attached to one another, such as through corner welds, to give case 110 a shape that substantially resembles a rectangular prism.

Case 110 provides, among other benefits, a barrier that isolates case interior space 113 and prevents materials for unintentionally entering or exiting. Similarly, case 110 provides safety through preventing users from unintentionally contacting device 100's harvesting elements, which could cause injury. Further, case 110 provides structural support many features of device 100.

As FIG. 1 illustrates, top panel 112i defines a substantially rigid, sheet-metal rectangular panel attached by corner welds to first side panel 112ii, second side panel 112iii, and rear panel 118.

As FIG. 1 illustrates, first side panel 112ii defines a substantially rigid, sheet-metal rectangular panel attached by corner welds to top panel 112i, rear panel 118, and bottom portion 114. As FIG. 1 shows, first side panel 112ii defines a first case access cover retainer 121i projecting into case interior space 113. As FIG. 1 shows, first case access cover retainer 121i defines a plurality of first case magnetically interactive materials 122i facing outward through open panel 116.

As FIG. 1 illustrates, second side panel 112iii defines a substantially rigid, sheet-metal rectangular panel attached by corner welds to top panel 112i, rear panel 118, and bottom portion 114, substantially similar to first side panel 112ii. As FIG. 1 illustrates, second side panel 112iii defines a second case access cover retainer 121ii defining a plurality of second case magnetically interactive materials 122ii, substantially similar to first side panel 112ii.

As FIG. 1 shows, second side panel 112iii includes a duct opening 107, to which a duct 108 connects case interior space 113 to a disposal area 109, such as an external air vent, to define a substantially enclosed fluid- and solid particulate-transmissive path extending between case interior space 113. As FIG. 1 illustrates, a fluid pump 105 is connected to duct 108 to better direct air flow from case interior space 113 to disposal area 109. Device 100 is configured to selectively direct fluid and solid particulate matter contained within case interior space 113 through duct 108 to disposal area 109 to reduce the amount of particulate matter contained within case 110 and the amount of particulate matter undesiredly given off in the area near device 100. This may be useful, for example, to reduce the amount of dust or solid particulate matter produced by device 100 when harvesting plant material. Some examples may not include any such structure to connect to disposal area 109. This may be particularly useful, for example, with examples wherein it is desired to save any discarded particulate matter, such as with hops or other plants that produce harvestable buds or flowers. Further, it may reduce the scent given off by device 100 when harvesting pungent plants.

As FIG. 2 shows, rear panel 118 is attached to first side panel 112ii, second side panel 112iii, top panel 112i, and bottom portion 114. Unlike top panel 112i, first side panel 112ii, second side panel 112iii, and bottom portion 114, rear panel 118 includes a polymer covering on its exterior surface. As FIG. 2 shows, rear panel 118 defines a plurality of vents 124 positioned above motor 130 and provide a fluid-transmissive path between case interior space 113 and the exterior of case 110. This allows the passage of moisture and/or heat from case interior space 113 to the environment. When trimming dry material, vents 124 may help regulate temperature within case interior space 113, thereby reducing the risk of igniting any plant particulate matter. By being positioned immediately above motor 130, vents 124 may be particularly efficient in releasing heat produced by motor 130 during operation. When trimming wet plant material, vents 124 may provide a path through which evaporated moisture may travel.

As FIG. 1 illustrates, open panel 116 defines a void that serves as a case access opening through which a user may access plant material from harvesting container 150, which is accessible through harvesting container access opening 162. In some examples, open panel 116 may include a rigid, sheet-metal panel, similar to other disclosed panels, over some or all of a portion of its surface rather than completely defining a void. In such examples, open panel 116 may include a case access opening that at least partially overlaps harvesting container access opening 162.

As FIG. 1 shows, case 110 additionally includes case access cover 119 removably supported to cover a portion of open panel 116. As FIG. 1 shows, case access cover 119 is substantially rigid and translucent, defining a plexiglass material. Using a rigid, translucent material reduces the likelihood that users' anatomy or exterior particulate matter unintentionally enters case interior space 113 while allowing users to continue viewing harvested material. This may prevent harm to users and reduce operational wear on the equipment. As FIG. 4 shows, case access cover 119 includes a case cover port 120 substantially centered on case access cover 119. Case cover port 120 allows users to better view the contents of harvesting container 150 while case access cover 119 provides a meaningful barrier to unintentional access within case access cover 119.

As FIG. 4 illustrates, case access cover 119 includes a plurality of case access cover magnetically interactive materials 117, each operatively paired with first case magnetically interactive materials 122i and second case magnetically interactive materials 122ii. As FIG. 1 illustrates, case access cover magnetically interactive materials 117 are positioned to align with first case magnetically interactive materials 122i and second case magnetically interactive materials 122ii when case 110 is in a fitted position in case 110, such as is seen in FIG. 1.

As FIG. 1 shows, bottom portion 114 is positioned below case interior space 113, and thus saddle 170 and harvesting container 150, and is attached to first side panel 112ii, second side panel 112iii, and rear panel 118. As FIG. 1 shows, bottom portion 114 provides a base for device 100 that collects any falling particulate matter and/or discarded plant material produced by device 100 during operation.

As FIG. 1 illustrates, bottom portion 114 includes a tray 128 slidingly supported within bottom portion 114 and facing case interior space 113, thus supported below saddle 170 and harvesting container 150. Tray 128 is positioned to collect falling particulate matter and/or discarded plant material produced by device 100 during operation. Tray 128 is configured to slide between an accumulating position substantially fully received within case 110, such as is seen in FIG. 1, and a dispensing position substantially outside the case. As FIG. 1 shows, tray 128 includes a tray handle 129 that allows a user to pull tray 128 from the accumulating position to the dispensing position.

As FIG. 1 shows, case 110 includes a safety device 125 supported by top panel 112i proximate open panel 116 and in electric communication with motor 130 via a safety wire 103. As FIG. 1 illustrates, safety device 125 includes a safety control box 127 and an outwardly biased safety device pin 126. Safety device 125 is configured to detect removal of case access cover 119 and is configured to communicate a signal to the motor to enter an idle state, in other words, cease operation, in response to removal of case access cover 119. The paired magnetically interactive materials help retain case access cover 119 in a substantially in place when in a fitted position in case 110.

As FIG. 1 illustrates, safety device pin 126 is configured to be pressed from an extended position with safety device pin 126 extending from out of safety control box 127 to a depressed position wherein safety device pin 126 is substantially received by safety control box 127 by case access cover 119 when case access cover 119 is supported in the fitted position in case 110 shown in FIG. 1. When case access cover 119 is removed, safety device pin 126 extends back to the extended position due to its outward biasing. When safety device pin 126 returns to this extended position, safety control box 127 is configured to communicate a signal to motor 130 to cease operation. In some examples, device 100 may be configured to prevent motor 130 from receiving electrical power unless safety device pin 126 in the depressed state. This prevents device 100 from operating without case access cover 119 supported in a fitted position in case 110, such as is seen in FIG. 1, which reduces the likelihood of users being harmed by unintentionally inserting anatomy into case interior space 113 during operation.

As FIG. 1 shows, saddle 170 is positioned within case 110. As FIG. 4 illustrates, saddle 170 longitudinally extends substantially horizontally from a front end 172 proximate open panel 116 to a rear end 174 proximate rear panel 118. As FIG. 4 illustrates, saddle 170 defines a substantially parabolic cross-section taken transverse its longitudinal axis along its entire length. As FIGS. 1 and 4 collectively show, saddle 170 this parabolic shape extends from a first saddle lateral edge 176 to a second saddle lateral edge 178, thereby defining a saddle-interior space 173 bounded by saddle 170's parabolic shape and top panel 112i. As FIGS. 1 and 4 show, saddle 170 defines a harvesting container-proximate region 171 over a portion of saddle 170's surface area. As FIG. 4 shows, saddle 170 defines a plurality of saddle openings 180.

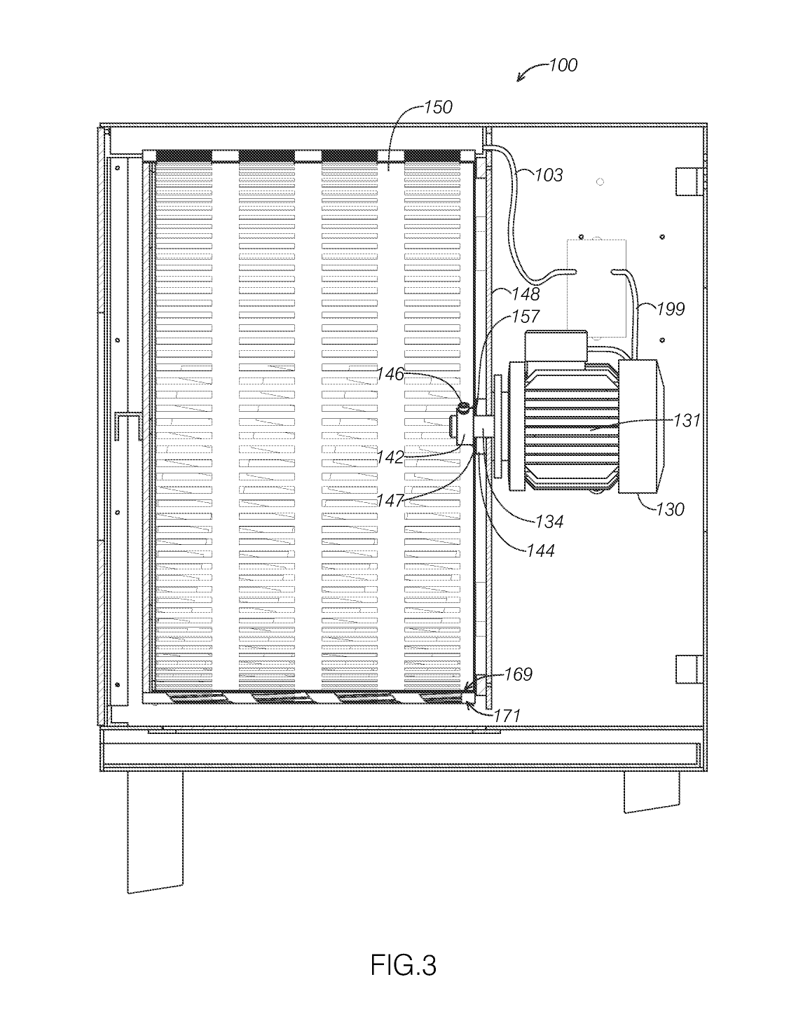

In the example shown in FIG. 3, harvesting container-proximate region 171 extends over a portion of saddle 170's interior surface area proximate its vertex. As FIG. 1 illustrates, harvesting container-proximate region 171 includes a substantial portion of saddle 170's interior surface area proximate harvesting container 150. As FIG. 4 illustrates, saddle 170 defines a curve over at least a portion (and indeed, all) of harvesting container-proximate region 171.

As FIG. 4 illustrates, saddle 170 includes a plurality of saddle attachment points 186i-iv, each positioned proximate a saddle lateral edge. As FIG. 4 shows, saddle attachment points 186i and 186ii are positioned proximate first saddle lateral edge 176 substantially near one endpoint of saddle 170's parabolic shape and saddle attachment points 186iii and 186iv are positioned proximate second saddle lateral edge 178 substantially near the opposite endpoint of saddle 170's parabolic shape. As FIG. 1 illustrates, a plurality of saddle fasteners 187 are each removably routed through a corresponding saddle fastener receiver 115 on top panel 112i and each saddle attachment point to substantially retain saddle 170 attached to and supported in case interior space 113 by top panel 112i. In some examples, the saddle fasteners may define wingnut and bolt combinations, wherein saddle attachment points 186i-iv and saddle fastener receivers 115 define holes through which the bolts may be routed and the wingnuts may be fastened either above top panel 112i or below saddle attachment points 186i-iv. Such configurations may allow saddle 170 to be removed, which may be useful in certain harvesting contexts; for example, this may be useful when using a harvesting container defining only a fine mesh.

In some contexts, some or all of harvesting container 150 is either in contact with or minimally spaced from saddle 170 over some or all of harvesting container-proximate region 171. In some examples, saddles may additionally or alternatively include a low-friction material applied to their surfaces on the side facing harvesting container 150, which may allow harvesting container 150 to be seated within and rotate within saddle 170 with less friction. This reduces the amount of heat applied to plant material in harvesting space 155, which makes device 100 particularly adaptable to harvesting dry plant material. In particular, the reduced friction may reduce the risk posed by friction-generated heat igniting particular plant material caught between harvesting container 150 and saddle 170. Further, this reduced friction may reduce operational wear. In some examples, this low-friction material may define Teflon or other chemically similar material. In many cases, device 100 may harvest most efficiently by minimizing the space between harvesting container 150 and saddle 170; applying a non-friction surface to either saddle 170's interior surface or harvesting container 150's exterior surface to mitigate any damage from so minimizing this space for the reasons discussed above.

As FIG. 1 shows, harvesting container-proximate region 171 is substantially proximate and aligned with approximately, but slightly less than, one half of the circumference of harvesting container 150. This size has provides a good amount of trimming space while reducing the likelihood of friction or stress resisting harvesting container 150's rotation within saddle 170. As FIG. 3 shows, harvesting container 150 may, in some examples, partially rest in harvesting container-proximate region 171. Because of the reduced surface area, and corresponding reduction in friction, compared to a dual-concentric design, device 100's saddle-and-drum make device 100 particularly suited to harvesting dry plant material. Further, because no harvesting occurs on the upper half of harvesting container 150, device 100 reduces the likelihood of particulate matter inadvertently entering the top half of case 110 (which would, in some examples, pose a fire risk or damage equipment).

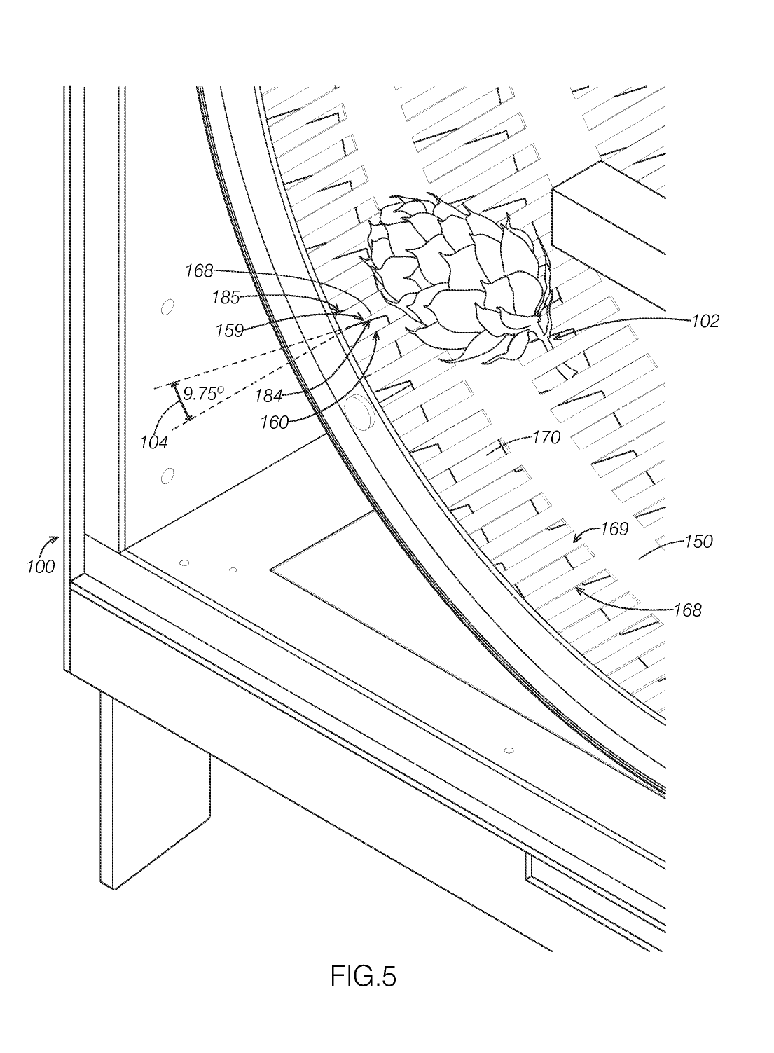

As FIG. 4 shows, saddle openings 180 are positioned over substantially all of saddle 170's surface, including within harvesting container-proximate region 171; as a result, saddle opening 180 collectively substantially define a saddle mesh 182. As FIG. 4 shows, saddle mesh 182 defines a plurality of equally sized, aligned parallelogram (which may be, in some examples, rectangular) openings that cover substantially all of saddle 170's surface area. As FIG. 5 demonstrates, each saddle opening 180 defines a first saddle opening lateral edge 184 and a second saddle opening lateral edge 185, wherein both of first saddle opening lateral edge 184 and second saddle opening lateral edge 185 are substantially linear and substantially parallel.

As FIG. 3 illustrates, motor 130 serves as a rotary mechanical actuator is supported within case 110 proximate rear panel 118 and is mechanically attached to harvesting container 150. As FIG. 3 illustrates, motor 130 is electrically powered, drawing energy from an external electrical power source, such as a electrical outlet 99, through a power cable 132 extending through case 110. As FIG. 3 shows, motor 130 serves as a rotary mechanical actuator, configured convert the received electrical energy by rotationally driving harvesting container 150 through a range of rotation via a rotary shaft 134.

As FIG. 4 illustrates, rigidly attached to motor 130's rotor 131. Accordingly, motor 130 is configured to rotationally drive rotary shaft 134 about rotary shaft 134's longitudinal axis. Rotary shaft 134 extends, when motor 130 is supported within case 110, toward case 110's open panel 116. As FIGS. 3 and 4 illustrate, rotary shaft 134 is configured to operatively pair harvesting container 150 with motor 130 by rigidly, but interchangeably, attaching to harvesting container 150 such that motor 130 drives harvesting container 150 via rotary shaft 134. Although rotary shaft 134 is round in the example displayed in FIG. 3, some examples may include rotary shafts that define a polygonal (or other non-circular) cross-section taken about its longitudinal axis. Such designs may increase the amount of torque the rotary shafts are able to translate to harvesting containers.

As FIG. 4 illustrates, harvesting container 150 is seated within saddle 170 and is operatively connected to motor 130. As FIG. 4 illustrates, harvesting container 150 substantially defines a hollow cylindrical drum defining a harvesting container exterior surface 151 circumferentially enclosing a harvesting space 155 and extending from an interior end 152 proximate rear panel 118 to an intake end 154 proximate open panel 116. As FIG. 4 illustrates, harvesting container 150's central longitudinal axis may additionally overlap or be aligned with saddle 170's focus. As FIG. 3 illustrates, harvesting container 150 includes a harvesting container back panel 156. As FIG. 4 illustrates, harvesting container back panel 156 defines a back panel opening 157. As FIGS. 4 and 5 illustrate, harvesting container 150 defines a plurality of harvesting container openings 158 positioned around its exterior.

As FIG. 4 shows, harvesting container 150 defines a harvesting container access opening 162 facing open panel 116. Users may access harvesting space 155 through harvesting container access opening 162, allowing users to insert unharvested plant material into harvesting space 155 and retrieve harvested plant material from harvesting space 155.

As FIG. 4 shows, device 100 includes a substantially rigid, translucent harvesting container access opening cover 167 configured to be supported by harvesting container 150 in harvesting container access opening 162 to cover substantially all of harvesting container access opening 162; FIG. 1 shows harvesting container access opening cover 167 positioned on harvesting container 150. Harvesting container access opening cover 167 is made of the same or similar plexiglass material as case access cover 119. Harvesting container access opening cover 167's translucency allows users to view harvesting space 155 while its rigidity provides a meaningful barrier preventing unintentional entry into harvesting space 155. As FIG. 1 shows, harvesting container access opening cover 167 includes a handle 166 that allows users the ability to insert and remove harvesting container access opening cover 167 from harvesting container 150. As FIG. 1 illustrates, case cover port 120 is substantially aligned with at least a portion of harvesting container access opening cover 167, requiring users to look through only one layer of plexiglass material in viewing harvesting space 155, thereby increasing the visibility of harvesting space 155 compared to an example with case access cover 119 covering all of open panel 116.

As FIG. 3 shows, harvesting container 150 defines a curvature 169 that is substantially similar to harvesting container-proximate region 171's curve, placing each point of saddle 170's interior surface substantially equidistant harvesting container 150. As FIGS. 4 and 5 show, harvesting container 150's perimeter is substantially circular, and, as a result, curvature 169 is substantially uniform around all of harvesting container 150's exterior.

As FIG. 3 illustrates, harvesting container 150 may be positioned within saddle-interior space 173, longitudinally extending substantially aligned with saddle 170's longitudinal axis. When so positioned, some or all of a portion of harvesting container exterior surface 151 may be minimally spaced from or interfacially engaged with saddle 170 over some or all of harvesting container-proximate region 171.

Harvesting container 150 includes a low-friction material applied to harvesting container exterior surface 151, reducing damage and heat that may otherwise result from friction between harvesting container 150 and saddle 170. Further, this may reduce the amount of heat generated during use, which may reduce the risk of unintentionally igniting plant material or particulate matter and may reduce the amount of operational damage to harvesting container 150 and/or saddle 170. In some examples, harvesting container 150 may be seated and substantially engaged with some or all of harvesting container-proximate region 171, whereby low-friction material reduces the amount of friction created as harvesting container 150 rotates. In some examples, the low-friction material may define Teflon.

As FIG. 4 illustrates, harvesting container 150 includes a plurality of harvesting container openings 158 positioned around harvesting container 150's perimeter to define a coarse harvesting container mesh 168. As FIG. 4 shows, coarse harvesting container mesh 168 defines a plurality of equally sized, aligned parallelogram (which may be, in some examples, rectangular) openings that cover substantially all of harvesting container 150's exterior. In some examples, either saddle openings, harvesting container openings, or both, may be circular, other polygonal shapes, or non-polygonal. While there is a set of substantially uniformly shaped and sized openings on both the illustrated saddles and harvesting containers, this is not specifically required. As FIG. 5 demonstrates, each harvesting container opening 158 defines a first container opening lateral edge 159 and a second container opening lateral edge 160, wherein both of first container opening lateral edge 159 and second container opening lateral edge 160 are substantially linear and substantially parallel. As FIG. 4 shows, harvesting container 150 includes a harvesting container harvesting surface, one example of which may be coarse harvesting container mesh 168, that is configured to contact and interact with contained plant material, for example, to harvest crops, such as buds or flowers, grind harvested crops, or otherwise adjust the state of the contained plant material.

The example shown in FIGS. 1-5 illustrate a coarse harvesting container mesh 168 with a screen sized to isolate a desired crop of a plant and discard unwanted plant material, which may include stem and/or leaves. As FIGS. 1-5 show, harvesting container 150 defines a coarse screen for harvesting container 150's intended use of coarsely harvesting crop from stems and/or leaves. As FIG. 5 shows, this coarse mesh is configured to receive at least a portion of an undesired portion of the plant, which may include leaves and/or stems, while maintaining substantially all of the crop, such as the bud of a hop or other plants that produce harvestable buds or flowers, within harvesting space 155. This large mesh is not, of course, appropriate for all contexts. Some contexts may require a finer or larger mesh, however. Some may be fitted to receive stems specifically, leaves specifically, or be adapted to other plants.

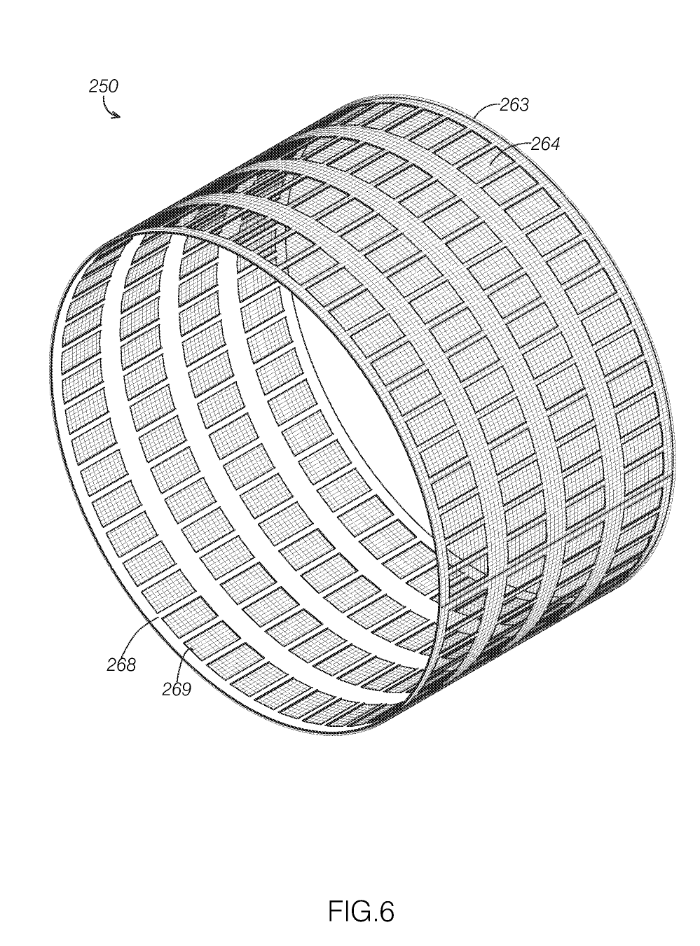

Some harvesting container examples, such as harvesting container 250 shown in FIG. 6, may include a fine mesh layer, such as fine harvesting container mesh 263 included additionally or alternatively to a coarse mesh layer, such as coarse harvesting container mesh 268 similar to coarse harvesting container mesh 168 (but with even larger openings). As FIG. 6 illustrates, fine harvesting container mesh 263 defines a plurality of fine openings 264 that are considerably smaller than harvesting container openings 158. As FIG. 6 shows, coarse harvesting container mesh 268 includes a plurality of coarse openings 269, which are larger than harvesting container openings 158 (and, by extension, substantially larger than fine openings 264). Further, as FIG. 6 shows, fine harvesting container mesh 263's solid areas are substantially thinner than coarse harvesting container mesh 168's.

As FIG. 6 illustrates, fine harvesting container mesh 263 is installed as an additional layer around the exterior of harvesting container 250 (exterior to coarse harvesting container mesh 268). This fine mesh may be useful in “grinding” crop into more fine particulate matter, which may be useful in creating a dense, concentrated powder of the plant material. Some harvesting container examples may include only a fine mesh layer substantially similar to fine harvesting container mesh 263. Including both layers, however, may increase efficacy in some examples, however. For example, the metal portions of the coarse mesh may, at times, deflect crop within the harvesting container's harvesting space, thereby increasing the velocity with which crop will hit the fine mesh or adjust the angle with which crop hits to fine mesh, which may increase the shearing force the fine mesh applies to the crop compared to an example including only a fine mesh. Further, some examples implementing a fine mesh may forgo the use of the saddle, which may increase the efficiency in which yielded crop is accumulated. Some examples may allow the saddle fasteners to be removed to detach saddles from cases.

As FIG. 4 shows, back panel opening 157 is substantially centered on harvesting container back panel 156. Back panel opening 157 is configured to removably attach harvesting container 150 to motor 130. Specifically, back panel opening 157 is sized and shaped to slidingly receive rotary shaft 134. Harvesting container 150 may be mechanically attached to motor 130 in by connecting harvesting container 150 via routing rotary shaft 134 through back panel opening 157.

As FIG. 3 shows, a fastener 140, may be attached to rotary shaft 134 to retain harvesting container 150 in a substantially fixed longitudinal position on rotary shaft 134. As FIG. 3 shows, fastener 140 includes a collar 142 is rigidly connected to harvesting container back panel 156 around back panel opening 157 and a bolt 146 configured to be screwingly received by collar 142 toward rotary shaft 134. As FIG. 3 shows, device 100 includes a fixed backstop 144 that prevents harvesting container 150 from sliding beyond a desired position on rotary shaft 134. As FIG. 4 shows, backstop 144 may include a plurality of low-friction backstop pads 147 attached to a backstop panel 148 positioned between harvesting container 150 and motor 130, the backstop pads configured to contact harvesting container 150 without substantially restricting its rotation. In some examples, however, backstops may define a metal (or other similarly rigid) radial projection projecting from rotary shafts between harvesting containers and motors.

To attach harvesting container 150 to motor 130, rotary shaft 134 may be slidingly received by back panel opening 157 until harvesting container back panel 156 is substantially fully engaged with backstop 144. When harvesting container 150 has fully received rotary shaft 134 such that harvesting container 150 is engaged with backstop 144, bolt 146 may be tightened within collar 142 to substantially fix fastener 140 in its longitudinal position on rotary shaft 134. Bolt 146 further retains harvesting container 150 in a substantially fixed radial position on rotary shaft 134, allowing motor 130 to rotationally drive harvesting container 150. In some examples, rotary shaft 134 may include an opening or a longitudinally extending channel to receive bolt 146 to better retain harvesting container 150 in a fixed radial position on rotary shaft 134. As a result, harvesting container 150 may be placed in substantially fixed position on rotary shaft 134 where it may be rotationally driven by motor 130 via rotary shaft 134.

Likewise, bolt 146 may, of course, be removed to remove harvesting container 150 from rotary shaft 134. Removing bolt 146 may involve, for example, unscrewing it from collar 142.

By allowing removal of harvesting container 150, device 100 allows additional or alternative examples of drums to be attached to rotary shaft 134 and operate similar to harvesting container 150. By providing users with an interchangeable harvesting container, users are able to selectively exchange drums to adapt device 100 to particular circumstances.

When so mechanically connected, motor 130 is configured to rotationally drive harvesting container 150 within saddle 170 about harvesting container 150's central longitudinal axis. As a result, motor 130 is configured to rotationally drive through a range of rotation. As motor 130 rotationally drives harvesting container 150, harvesting container 150 may travel through a range of one or more harvesting positions wherein at least one harvesting container opening 158 at least partially overlaps a saddle opening 180. FIG. 5 provides details of one such harvesting position, harvesting position 102.

As FIG. 5 illustrates, at each harvesting position 102, first container opening lateral edge 159 and first saddle opening lateral edge 184 of the associated overlapped harvesting container opening 158 and saddle opening 180 are misaligned with one another by a predetermined harvesting angle 104. Predetermined harvesting angle 104 has been selected to roughly translate to the angle of a pair of trimming shears, such as a scissors, that has been found to be particularly successful in trimming plant material. This disclosure notes that harvesting angles ranging of 9.5 degrees to 10 degrees have been found to be particularly successful in trimming plant material, particular with regard to trimming hops or other plants that produce harvestable buds or flowers. Disclosed examples are not, however limited to this range. Indeed, different angles may be more appropriate for other example plant materials.

As FIGS. 1 and 5 show, the first lateral edges of each saddle and harvesting container opening each define a substantially uniform trimming angle at each harvesting position. This disclosure notes that this uniformity may help produce a more uniform harvested crop.

As FIG. 2 shows, control panel 190 is positioned on first side panel 112ii and includes wiring (not shown) placing it in electrical communication with power cable 132 and motor 130. As FIG. 2 shows, control panel 190 includes an on button 191, an off button 192, a timed harvest button 193, and a timer 194. Control panel 190 is configured to receive user input and send electrical signals, via a control panel wire 199, that are configured to adjust motor 130 between an operating state wherein the motor automatically drives harvesting container 150 and an idle state wherein the motor is substantially stationary in response to received user input. Control panel 190 is powered by power cable 132 (or, in some examples, motor 130 by way of an inverter), and is configured to communicate electric signals to motor 130 adjust its behavior.

For example, on button 191 may communicate a signal to adjust motor 130 to an operating state in response to user selection. This may be useful, of course, for users to instruct harvesting container 150 to begin harvesting plant material contained within harvesting space 155.

Similarly, off button 192 may communicate a signal to adjust motor 130 to an idle state in response to user selection. This may be useful, of course, for users to instruct harvesting container 150 to stop harvesting plant material contained within harvesting space 155.

As FIG. 2 shows, timer 194 includes a display 195, an add time button 196, and a remove time button 197. Users may adjust a user-selected segment of time by selecting add time button 196 and remove time button 197. In many examples, add time button 196 will add an incrememt of time, such as a minute, to the user-selected segment of time, whereas remove time button 197 will remove the same increment of time from the user-selected segment of time. At any given time, display 195 will reflect the current user-selected segment of time.

Timed harvest button 193 is configured to communicate a signal or signals to retain motor 130 in an operating state for the user-selected segment of time depicted by timer 194. As device 100 performs a timed harvest in response to selecting timed harvest button 193, the user-selected segment of time will be appropriately reduced during operation. Users may lengthen or shorten the user-selected segment of, and thus the remaining duration of the timed harvest, by selecting add time button 196 or remove time button 197.

As FIG. 2 shows, control panel 190 additionally includes an intensity adjustment 198, which allows users to adjust the speed at which harvesting container 150 rotates within saddle 170 by communicating an electric signal to motor 130 to either increase or decrease its rotations per minute.

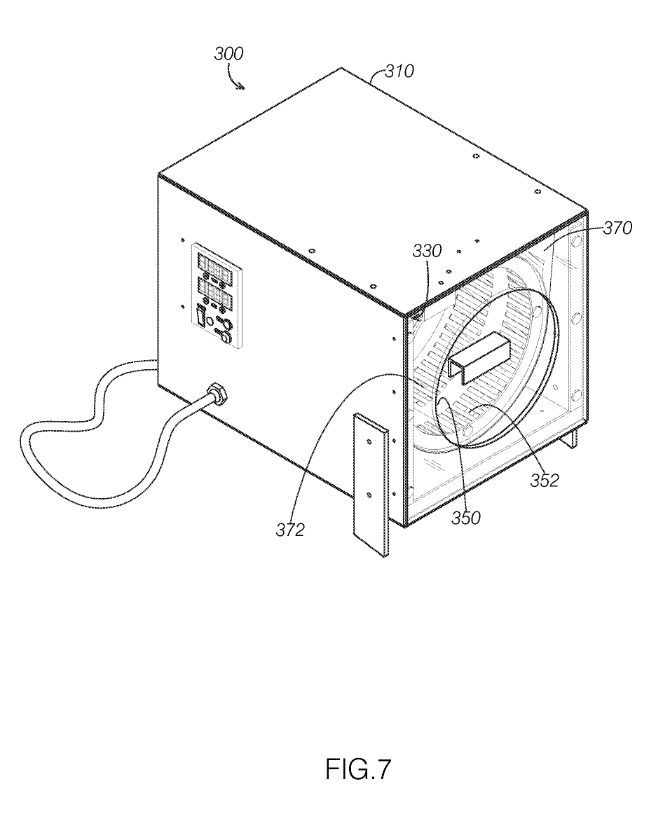

With reference to FIG. 7, a second example of a mechanical plant harvesting device, device 300, will now be described. As FIG. 7 illustrates, device 300 is substantially similar in design to device 100. Indeed, device 300 includes a case 310, a saddle 370, a harvesting container 350, and a motor 330, each substantially similar in design to case 110, saddle 170, harvesting container 150, and motor 130, respectively. Each of these components, while similar in design, are significantly reduced in dimension. Device 300 is not merely a smaller version of device 100, however, as saddle 370 and harvesting container 350 includes both saddle openings 372 and harvesting container openings 350 that are substantially the same size as saddle openings 180 and harvesting container openings 158. As a result, device 300 provides exactly the same efficacy as device 100 in trimming devices. Device 300's smaller design makes it more practical and accessible for individuals and home users. Further, device 300 is considerably more portable, allowing users to easily transport device 300 to areas where plant material is stored. Indeed, this disclosure specifically contemplates smaller devices such as device 300 that are battery powered, which provide a great deal more portability. Indeed, smaller devices, such as device 300, may even be transported to the place where plant material is grown to complete harvesting the plant material on the spot.

Some examples of devices including harvesting container retaining members may include fasteners attached to harvesting container retaining members to retain harvesting containers in substantially fixed longitudinal positions on the harvesting container retaining members.

In some examples of devices including trays, the trays may include tray handles.

In some examples of devices including cases and motors, the cases may define vents proximate the motors, the vents configured to provide a path through which heat may release from the interiors of the cases.

Some examples may include rigid, substantially translucent harvesting container covers removably supported by harvesting containers in harvesting container access openings to cover substantially all of the harvesting container access openings. In some such examples, the case access covers may define cover openings sized to allow insertion and removal of the harvesting container covers.

In some examples with safety devices, the safety devices may each include an outwardly biased safety device pin that is configured to be pressed from an extended position to a depressed position by the case access cover when the case access cover is supported in a fitted position in the case.

In some examples, saddles may define pluralities of attachment points fastened to top panels of cases and saddle-interior spaces bounded by the top panel of the cases and the saddles and the harvesting containers may be supported within the saddle-interior spaces.

Some examples may additionally or alternatively include control panels including a level adjustment input configured to communicate a signal that instructs the motor to rotate the harvesting container with a selected angular velocity.

Some examples may include control panels that additionally or alternatively include an on button configured to communicate a signal that instructs the motor to enter the operating state in response to user selection.

Some examples may include control panels that additionally or alternatively include an off button configured to communicate a signal that instructs the motor to enter the idle state in response to user selection.

Some examples may define harvesting container-proximate regions that extend over less than one half of the circumference of the harvesting container.

In some examples, the mechanical actuator may include a motor.

Some examples may include first container opening lateral edges that are misaligned with first saddle lateral edges of a partially overlapping saddle openings at predetermined trimming angles at each harvesting position.

Some examples may include harvesting containers that define harvesting container meshes over their entire exterior surface areas, wherein the harvesting container meshes define pluralities of spaced harvesting container openings.

In some examples, harvesting containers may define harvesting container access openings on open ends of the harvesting containers and the cases may define case access openings overlapping at least a portion of the harvesting container access openings. Such examples may additionally or alternatively include rigid, translucent case access covers removably supported by the case to cover at least a portion of the case access openings.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A mechanical plant harvesting device for harvesting crops from plant material, comprising:
a saddle, the saddle defining:
a harvesting container-proximate region over a portion of the surface area of the saddle; and
a saddle opening positioned within the harvesting container-proximate region;
a harvesting container defining:
an exterior surface proximate the saddle over at least a portion of the harvesting container-proximate region of the saddle, the exterior surface circumferentially enclosing a harvesting space; and
a harvesting container opening on the exterior surface;
a rotary actuator mechanically connected to the harvesting container, the rotary actuator configured to rotationally drive the harvesting container through a range of rotation; and
wherein a portion of the harvesting container opening and a portion of the saddle opening overlap at one or more harvesting positions in the rotary actuator's range of rotation.

2. The device of claim 1, wherein:
the harvesting container defines a substantially cylindrical drum that is substantially open on an intake end.

3. The device of claim 2, wherein the saddle:
longitudinally extends parallel to the harvesting container's longitudinal axis;
defines a parabolic shape that includes a substantially parabolic cross-section taken transverse its longitudinal axis; and
is curved over substantially all of the harvesting container-proximate region;
wherein the saddle partially encloses a saddle-interior space bounded by the saddle's parabolic shape; and
wherein the harvesting container defines a curvature placing each point on the harvesting container-proximate region substantially equidistant to the harvesting container.

4. The device of claim 3, wherein the harvesting container defines a harvesting container mesh over its entire exterior surface area, the harvesting container mesh defining a plurality of spaced harvesting container openings; and
wherein the plurality of spaced harvesting container openings defines a plurality equally spaced, harvesting container openings wherein each opening defines a substantially linear first container opening lateral edge and a substantially linear second container opening lateral edge that is substantially parallel to the first container opening lateral edge.

5. The device of claim 4, wherein the saddle defines a saddle mesh over all of the harvesting container-proximate region, the saddle mesh defining a plurality of saddle openings wherein each opening defines a substantially linear first saddle opening lateral edge and a substantially linear second saddle opening lateral edge that is substantially parallel to the first saddle opening lateral edge; and
wherein the first container opening lateral edge is misaligned with the first saddle opening lateral edge of a partially overlapping saddle opening at a predetermined trimming angle at each harvesting position.

6. The device of claim 5, wherein the predetermined trimming angle is selected from a range of 9.5 degrees to 10 degrees.

7. The device of claim 5, wherein:
each unit of plant material defines an undesired portion and a crop; and
the harvesting container openings and the saddle openings are sized to receive the undesired portion but restrict passage of the crop.

8. The device of claim 2, further comprising a case enclosing an interior space; and
wherein the saddle and the harvesting container are contained within the interior space.

9. The device of claim 8, wherein:
the harvesting container defines a harvesting container access opening on the intake end of the harvesting container;
the case defines a case access opening overlapping at least a portion of the harvesting container access opening; and
further comprising a rigid, translucent case access cover removably supported by the case to cover at least a portion of the case access opening;
further comprising a safety device attached to the case, the safety device:
configured to detect removal of the case access cover; and
in electric communication with the rotary actuator and configured to communicate a signal to the rotary actuator to cease operation in response to removal of the case access cover; and
wherein the safety device includes an outwardly biased safety device pin that is configured to be pressed from an extended position to a depressed position by the case access cover when the case access cover is supported in a fitted position in the case.

10. The device of claim 8, wherein:
the harvesting container defines a harvesting container access opening on the intake end of the harvesting container;
the case includes a case access cover retaining member projecting into the interior space, the case access cover retaining member including an outwardly facing case magnetically interactive material; and
the case access cover includes an case access cover magnetically interactive material operatively paired with the case magnetically interactive material to retain the case access cover in a fitted position in the case;
further comprising a rigid, substantially translucent harvesting container cover removably supported by the harvesting container in the harvesting container access opening to cover substantially all of the harvesting container access opening; and
wherein the case access cover defines a cover opening sized to allow insertion and removal of the harvesting container cover.

11. The device of claim 8, wherein the case defines a duct opening; and
further comprising:
a duct connected to the duct opening, the duct defining a substantially enclosed fluid- and solid particulate-transmissive path extending between the interior of the case and a disposal area; and
a fluid pump attached to the duct configured to direct fluid and solid particulate matter from the interior of the case to the disposal area.

12. The device of claim 8, wherein the case includes a tray slidingly supported below the harvesting container and the saddle, the tray configured to slide between an accumulating position substantially fully received within the case to a dispensing position substantially outside the case.

13. The device of claim 2, further comprising a low-friction material applied to the exterior surface of the harvesting container; and
wherein the harvesting container contacts the saddle over at least a portion of the harvesting container-proximate region.

14. The device of claim 1, wherein the rotary actuator defines an electrically powered motor; and
further comprising a power cable extending from the exterior of the device, the power cable configured to deliver to the motor electricity received an electrical outlet.

15. The device of claim 14, further comprising a control panel in electrical communication with the motor, the control panel configured to send communication to the motor that configured to adjust the motor between an operating state wherein the motor automatically and continuously drives the harvesting container and an idle state wherein the motor is substantially stationary in response to user input.

16. A mechanical plant harvesting device for harvesting crops from plant material, comprising:
a saddle, the saddle defining:
a harvesting container-proximate region over a portion of the surface area of the saddle; and
a saddle opening positioned within the harvesting container-proximate region;
a harvesting container, the harvesting container defining:
an exterior surface proximate the saddle over the harvesting container-proximate region of the saddle, the exterior surface circumferentially enclosing a trimming space; and
a harvesting container harvesting surface shaped to isolate a crop of the plant material in the trimming space; and
a mechanical actuator interchangeably mechanically attached to the harvesting container, the mechanical actuator configured to drive the harvesting container through a range of harvesting positions.

17. The device of claim 16, wherein the harvesting container harvesting surface includes a harvesting container opening positioned to overlap with a portion of the saddle opening overlap at one or more harvesting positions.

18. The device of claim 16, wherein:
the mechanical actuator includes a harvesting container retaining member, the mechanical actuator configured to rotationally drive the harvesting container retaining member; and
the harvesting container defines a harvesting container back panel on an interior end of the harvesting container, the harvesting container back panel defining a back panel opening sized and shaped to receive the harvesting container retaining member; and
further comprising a fastener attached to the harvesting container retaining member to retain the harvesting container in a substantially fixed longitudinal position on the harvesting container retaining member.

19. A mechanical plant harvesting device for harvesting crops from plant material, comprising:
a saddle, the saddle defining:
a harvesting container-proximate region over a portion of the surface area of the saddle; and
a saddle opening positioned within the harvesting container-proximate region;
a harvesting container defining:
an exterior surface interfacially engaged with the saddle over the harvesting container-proximate region of the saddle, the exterior surface circumferentially enclosing a trimming space; and
a fine harvesting container mesh disposed on the exterior of the harvesting container;
a rotary actuator mechanically attached to the harvesting container, the rotary actuator configured to rotationally drive the harvesting container through a range of rotation; and
wherein a portion of the harvesting container opening and a portion of the saddle opening overlap at one or more harvesting positions in the rotary actuator's range of rotation.

20. The device of claim 19, wherein:
the fine harvesting container mesh defines a fine mesh layer;
the fine harvesting container mesh defines a plurality of fine openings; and
the harvesting container mesh includes a coarse mesh layer including a coarse harvesting container mesh defining a plurality of coarse openings, each of the coarse openings substantially larger than each of the fine openings.
